(19) United States
(12) Patent Application Publication
(10) Pub. No.: US 2010/0295791 A1
(43) Pub. Date: Nov. 25, 2010

(54) PORTABLE INFORMATION TERMINAL, CHARACTER DELIVERY METHOD; AND CHARACTER TEMPORARY STORAGE PROGRAM PRODUCT

(76) Inventors: Shunji Nishimura, Osaka (JP); Makiko Andoh, Osaka (JP)

Correspondence Address: BIRCH STEWART KOLASCH & BIRCH, PO BOX 747, FALLS CHURCH, VA, 22040-0747, US

(21) Appl. No.: 12/864,435

(22) PCT Filed: Jan. 21, 2009
(86) PCT No.: PCT/JP2009/050815

§ 371 Date: Jul. 23, 2010

(30) Foreign Application Priority Data
Jan. 25, 2008 (JP) 2008-015041

(51) Int. Cl. G06F 3/02; G06F 3/048

(52) U.S. Cl. 345/168; 715/764

(57) ABSTRACT

A temporary storage control unit includes an input processor unit for performing a process of temporarily storing characters input through an operation unit into a volatile storage device, a display processor unit for performing a process of causing a display unit to display input characters, and an instruction acceptance unit for accepting a paste instruction related to a paste destination of characters temporarily stored. A paste control unit activates another program corresponding to a paste destination, and pastes the characters temporarily stored into a character input region according to the activated program.

### TECHNICAL FIELD

The present invention relates to a portable information terminal, a character delivery method, and a character temporary storage program product. Particularly, the present invention relates to a portable information terminal, character delivery method, and character temporary storage program product allowing acceptance of character input from a user.

### BACKGROUND ART

Recent portable information terminals have the capability for registering characters entered by a user as a memo and the capability for executing a Web search upon input of a keyword. Since these functions are realized by different applications, each application must be activated individually for the user to execute each function.

In an apparatus capable of accepting character entry, approaches are conventionally made to reduce the burden of operation by the user. For example, Japanese Patent Laying-Open No. 03-40065 (Patent Document 1) discloses a document generation apparatus storing document formats and registration information. When a document is to be produced according to the format selected by the user, registration information corresponding to that format is also read out, and individual information is added to the document name data in the registration information to generate a unique document name. The generated unique document name is added to the generated/edited document data for automatic registration in a storage medium. Thus, the operator does not have to enter the format, document name, and registration information each time.

There is also proposed an approach to reduce the trouble of having to activate an application individually by the user. For example, Japanese National Patent Publication No. 2003-523568 (Patent Document 2) discloses assigning and registering a name in advance to an application group, allowing a plurality of related applications to be activated simultaneously upon input of a relevant name.

Patent Document 1: Japanese Patent Laying-Open No. 03-40065

Patent Document 2: Japanese National Patent Publication No. 2003-523568

### DISCLOSURE OF THE INVENTION

### Problems to be Solved by the Invention

However, even if the technique of Japanese Patent Laying-Open No. 03-40065 (Patent Document 1) is employed, the user cannot use the registered document as character information in another application through a simple operation. The invention of Japanese National Patent Publication No. 2003-523568 (Patent Document 2) allowing a plurality of applications to be started simultaneously cannot transfer characters between different applications in a flexible manner.

The present invention is directed to solving the aforementioned problem. An object of the present invention is to provide a portable information terminal, character delivery method, and character temporary storage program product that allows usage of character information entered by a user as character information in various applications through a simple operation.

### Means for Solving the Problems

A portable information terminal according to an aspect of the present invention is directed to a portable information terminal capable of accepting input of a character. The portable information terminal includes an operation unit for accepting input of an instruction by a user, a display unit, a storage unit for storing a first program to implement a temporary storage function of characters, a plurality of second programs related to input of characters, and information to operate the portable information terminal, and a temporary storage control unit for controlling temporary storage of characters based on the first program when a specific instruction is input from the operation unit. The temporary storage control unit includes an input processor unit accepting input of characters from the user via the operation unit for performing a process of temporarily storing input characters in the storage unit, a display processor unit for performing a process of causing the display unit to display characters accepted at the input processor unit, and an instruction acceptance unit for accepting a paste instruction to specify a program, out of the plurality of second programs, related to a paste destination of the characters temporarily stored in the storage unit. The portable information terminal further includes a paste control unit responsive to acceptance of a paste instruction at the instruction acceptance unit for activating a program related to the paste destination, and pasting the temporarily stored characters into a character input region in accordance with the activated program.

Preferably, the display processor unit further displays, when a predetermined instruction is input, a list of a plurality of types of character paste destinations corresponding to the plurality of second programs, respectively, and the instruction acceptance unit accepts selection of one of the plurality of types of character paste destinations as a paste instruction.

Preferably, the temporary storage control unit terminates the first program in response to acceptance of a paste instruction by the instruction acceptance unit.

Preferably, the portable information terminal further includes a specific control unit for carrying out control based on a specific program out of the plurality of second programs. The specific control unit includes an extraction unit for extracting, under a specific activation state where a display subject region corresponding to a specific program is displayed at the display unit, at least a portion of a character string in the display subject region, when a specific instruction is input. The temporary storage control unit temporarily stores characters based on the character string extracted by the extraction unit into the storage unit.

Preferably, the display processor unit displays a character string extracted by the extraction unit at the display unit. The input processor unit further accepts editing of a character string temporarily stored in the storage unit.

Preferably, the specific program includes at least one of a mail program and a Web browser.

Preferably, the portable information terminal further includes a communication control unit for performing communication control. The plurality of second programs include a mail program corresponding to a mail function via the communication control unit. When the activated program is the mail program, the character input region includes a mail body text region.

Preferably, the plurality of second programs includes the Web browser. When the activated program is the Web browser, the character input region includes an input region of search characters.

Preferably, the plurality of second programs include an address program corresponding to a function of address registration. The temporary storage control unit further includes a recognition processor unit for executing a recognition process of a character string temporarily stored to extract at least one of a name, telephone number and mail address when the activated program is an address program. The paste control unit pastes the extracted character string into the address input region based on the recognition process.

Preferably, the operation unit includes a button to implement a temporary storage function through only one operation in a temporary storage standby state or specific activation state.

Preferably, the storage unit includes a nonvolatile storage device for storing a first program and second program, and a volatile storage device for storing character data to be temporarily stored.

A character delivery method according to an aspect of the present invention is directed to a method for delivering characters between different programs in a portable information terminal including an operation unit for accepting input of an instruction from a user, a storage unit, and a processing unit. The character delivery method includes the steps of: activating a first program, out of a plurality of programs related to input of characters stored in the storage unit, to implement a temporary storage function of characters when a specific instruction is input by the operation unit; temporarily storing characters input via the operation unit into the storage unit based on the first program; accepting a paste instruction to specify a second program, out of the plurality of programs, related to a paste destination of the temporarily stored characters; activating the second program in response to acceptance of a paste instruction; and pasting the temporarily stored characters into a character input region according to the second program.

A character temporary storage program product according to another aspect of the present invention is directed to a program product for temporarily storing characters to deliver characters between different programs. The character temporary storage program product causes a computer to execute the steps of temporarily storing characters input by a user, and accepting a paste instruction to specify a program, out of other plurality of programs, related to a paste destination of the temporarily stored characters.

### EFFECTS OF THE INVENTION

According to the present invention, temporarily stored characters can be used as character information in various applications desired by the user.

Moreover, since the plurality of types of character paste destinations are displayed in a list, temporarily stored characters can be delivered to another application through a simple select operation by the user.

### BRIEF DESCRIPTION OF THE DRAWINGS

FIG. 1 is a schematic diagram of a portable information terminal according to an embodiment of the present invention.

FIG. 2 represents an appearance of a portable information terminal according to an embodiment of the present invention.

FIG. 3 represents the inner surfaces of first and second casings of a portable information terminal according to an embodiment of the present invention.

FIG. 4 is a hardware block diagram representing a hardware configuration of a portable information terminal according to an embodiment of the present invention.

FIG. 5 represents an exemplified arrangement of a plurality of keys in the operation unit of a portable information terminal according to an embodiment of the present invention.

FIG. 6 is a functional block diagram representing a functional configuration of a portable information terminal according to an embodiment of the present invention.

FIG. 7 is a flowchart of an interruption process executed when a temporary memo key is depressed according to an embodiment of the present invention.

FIG. 8 is a flowchart of an interruption process executed when a temporary memo key is depressed according to an embodiment of the present invention.

FIG. 9 is a flowchart of an interruption process executed when a temporary memo key is depressed according to an embodiment of the present invention.

FIG. 10 is a flowchart of an interruption process executed when a temporary memo key is depressed according to an embodiment of the present invention.

FIG. 11 represents an exemplified transition of a temporary memo input screen in a single activation mode.

FIG. 12 represents an exemplified screen displayed when “registration in memo pad” is selected at step S120 of FIG. 7.

FIG. 13 represents an exemplified transition of a screen displayed when “mail generation” is selected at step S120 of FIG. 7.

FIG. 14 represents an exemplified transition of a screen displayed when “registration in schedule book” is selected at step S120 of FIG. 7.

FIG. 15 represents an exemplified transition of a screen when “Web search” is selected at step S120 of FIG. 7.

FIG. 16 represents an exemplified transition of a screen displayed when “registration in address book” is selected at step S120 of FIG. 7.

FIG. 17 represents an exemplified transition of a screen displayed when “save text” is selected at step S120 of FIG. 7.

FIG. 18 represents an exemplified transition of a screen when in multi-activation with the mail program.

FIG. 19 represents an exemplified transition of a screen when in multi-activation with the browser program.

### DESCRIPTION OF THE REFERENCE SIGNS

1 portable information terminal; 7 antenna; 10 first casing; 10A hinge; 12 sub display unit; 14 image pickup unit; 16 main display unit; 18 reproduction circuit; 19 speaker; 20 second casing; 22 operation unit; 24 microphone; 25 time keeper unit; 26 access unit; 26A recording medium; 30 control unit; 36 communication control unit; 37 wireless unit; 38 audio signal processor unit; 40 storage unit; 100 temporary memo control unit; 102 input processor unit; 104 display processor unit; 106 instruction acceptance unit; 107 character recognition unit; 108 paste control unit; 110 specific control unit; 112 extraction unit; 224 temporary memo key; 215 determination key; 220 first key group; 230 second key group; 300 portable terminal network; 302 base station; 303 information providing server; 304 mail server; 306 Internet; 308 Web server; 401 RAM; 402 ROM; 403 flash memory

### BEST MODES FOR CARRYING OUT THE INVENTION

Embodiments of the present invention will be described in detail hereinafter with reference to the drawings. In the drawings, the same or corresponding elements have the same reference characters allotted, and description thereof will not be repeated.

In the following description, a portable information terminal 1 of the present embodiment will be described as a cellular phone. Portable information terminal 1 is not limited to a cellular phone, and may be a PDA (Personal Digital Assistant) or the like.

<Overview, Appearance, and Configuration>

First, the overview, appearance, and configuration of portable information terminal 1 according to the present embodiment will be described.

(Overview)

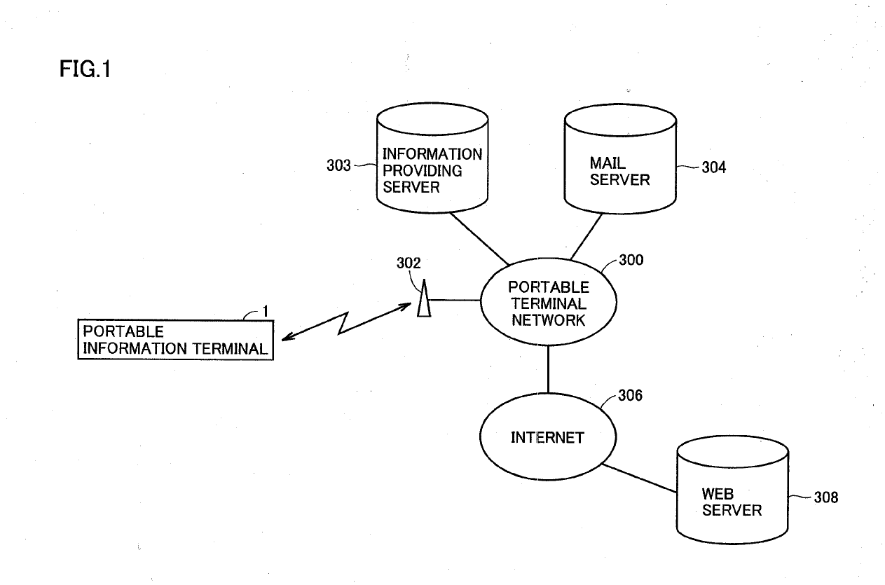

Referring to FIG. 1, portable information terminal 1 is connected to a portable terminal network 300 via a base station 302. Portable terminal network 300 is connected to an information providing server 303 and a mail server 304 exclusive to a cellular phone. Portable terminal network 300 is also connected to Web server 308 via the Internet 306.

Information providing server 303 and Web server 308 accept a requirement from portable information terminal 1 and search for information matching the requirement. The result of retrieval is transmitted to portable information terminal 1.

Mail server 304 transmits the mail (communication mail) from portable information terminal 1 to another cellular phone and/or PC (Personal Computer). Mail server 304 retains the mail (reception mail) addressed to portable information terminal 1 to transmit the retained reception mail to portable information terminal 1 when accessed thereby.

(Appearance)

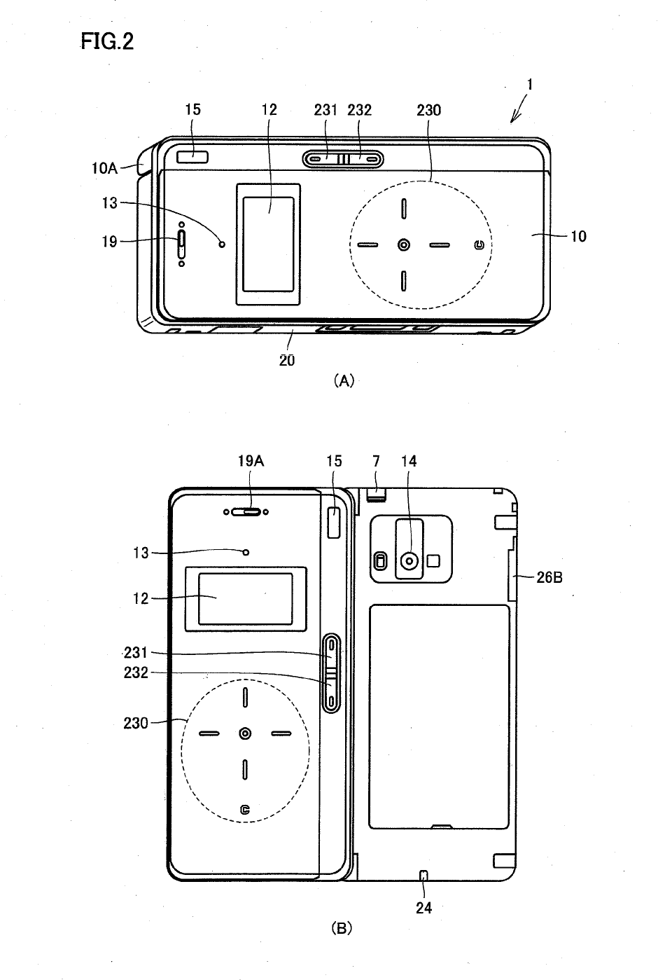

Referring to FIG. 2 showing an appearance of portable information terminal 1 according to an embodiment of the present invention, portable information terminal 1 is a fold-type cellular phone. In FIG. 2, (A) represents a perspective view of portable information terminal 1 in a folded state from the front, and (B) represents a plan view of portable information terminal 1 in an open state. Portable information terminal 1 of the present embodiment allows conversation mainly in a folded state.

Portable information terminal 1 includes a first casing 10 corresponding to the front face, and a second casing 2 corresponding to the back face. In a folded state, the surface shape of first and second casing 10 and 20 is substantially rectangular. First casing 10 and second casing 20 are switched between an open state and closed state by means of a hinge 10A provided at the upper end in FIG. 2(A).

At the outer face of first casing 10 are provided, for example, a sub display unit 12, an LED (Light Emitting Diode) 13, an earpiece speaker 19A, an infrared transmission/reception port 15, a touch key 230, an off-hook key 231 to accept a dispatch procedure, and an on-hook key 232 for accepting a call-ending procedure or an instruction to terminate a process. Sub display unit 12 provides the display of information such as the current date and time, a caller, a mail sender, and the like.

Touch key 230 is also referred to as a static key, relevant to a small plate-like device embedded in first casing 10. Touch key 230 functions as a cursor key and determination key. Through operation of touch key 230 by a user, a desired caller can be selected from the calling history displayed at sub display unit 12.

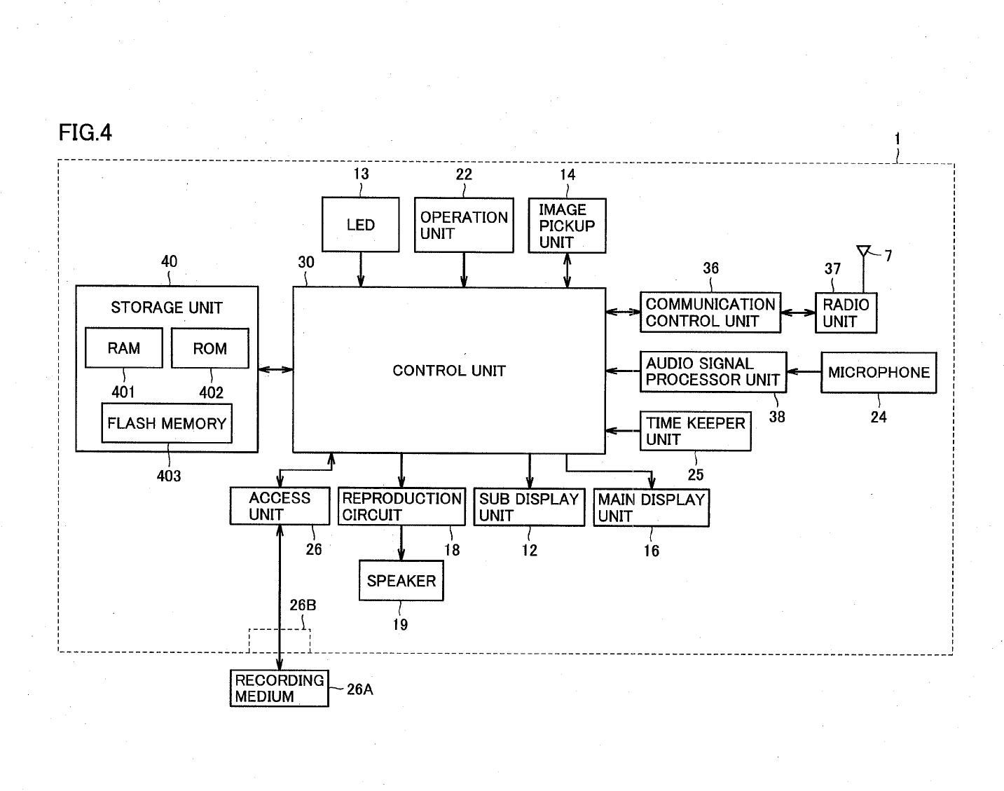

At the outer surface of second casing 20 are provided an antenna 7 that can be pulled out, an image pickup unit 14 for taking a picture of an object, a microphone 24, and a slot 26B to insert a detachable recording medium 26A (FIG. 4).

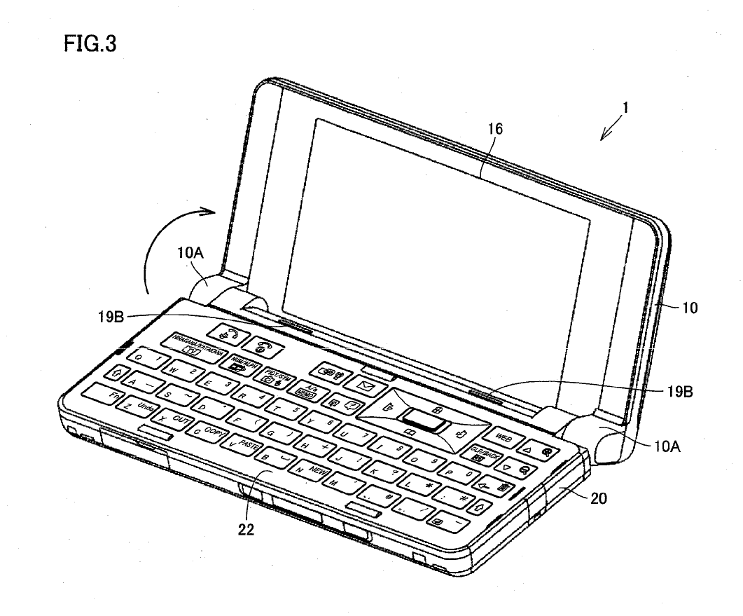

FIG. 3 represents first casing 10 and second casing 20 separated with hinge 10A therebetween.

Referring to FIG. 3, a main display unit 16 is provided substantially entirely over the inner surface of first casing 10. Various screens for character entry, a Web search screen, and the like are displayed at main display unit 16. Main display unit 16 allows a left and right divided display of two screens.

An operation unit 22 for accepting an instruction from the user is provided substantially entirely over an inner surface of second casing 20. At second casing 20 corresponding to the side of first casing 10, a speaker 19B is provided. Operation unit 22 includes a plurality of keys. The specific arrangement of these keys will be described afterwards. The aforementioned touch key 230, off-hook key 231 and on-hook key 232 are included in the function of operation unit 22.

Portable information terminal 1 of the present embodiment accepts input of a character via operation unit 22 in an open state of first casing 10 and second casing 20.

The configuration of portable information terminal 1 is not limited to that set forth above.

(Hardware Configuration)

Referring to FIG. 4, portable information terminal 1 includes, in addition to the components set forth above, a control unit 30, a storage unit 40, an antenna 7, a radio unit 37, a communication control unit 36, an audio signal processor unit 38, a reproduction circuit 18, a time keeper unit 25, and an access unit 26.

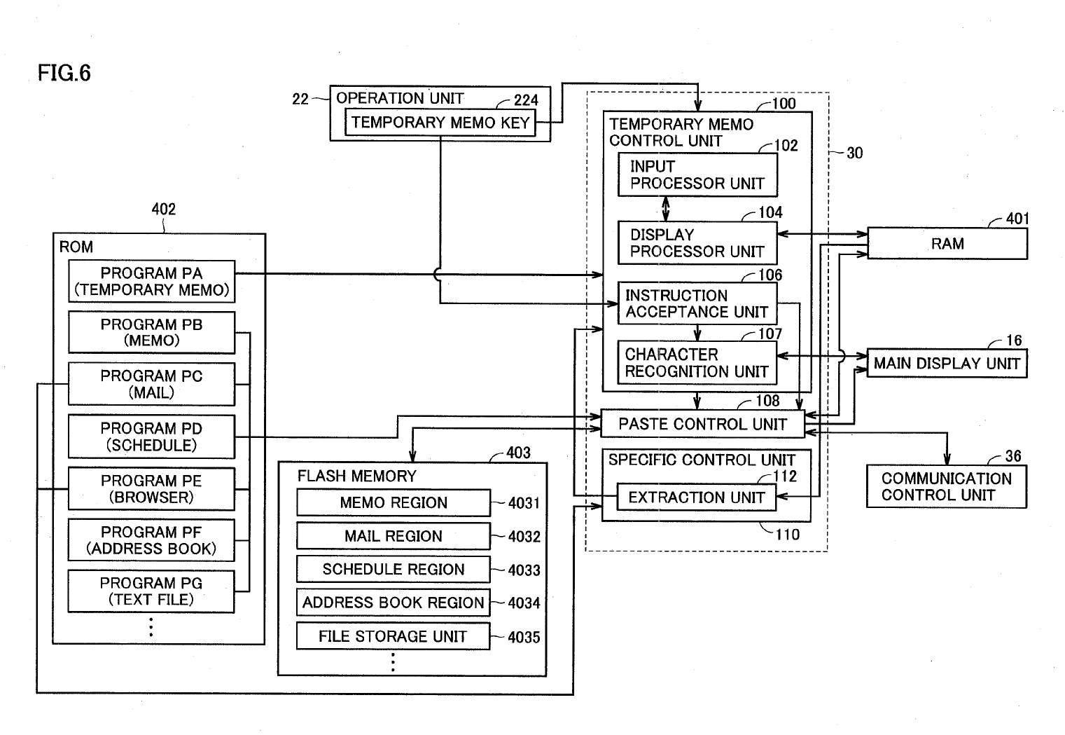

Control unit 30 is formed of a CPU (Central Processing Unit), for example. Control unit 30 performs the overall control of portable information terminal 1, as well as various computational processing. The function of control unit 30 will be described afterwards with reference to FIG. 6.

Storage unit 40 includes a RAM (Random Access Memory) 401 to temporarily store various data, a ROM (Read Only Memory) 402 to store in advance a plurality of programs and various data, and a flash memory 403 capable of update of various data and programs. Namely, storage unit 40 includes ROM 402 and flash memory 403 as nonvolatile storage devices, and RAM 401 as a volatile storage device. Although the present embodiment will be described with two types of nonvolatile storage devices, only one type (only flash memory 403) may be provided instead.

Radio unit 37 includes a modulation/demodulation function. Communication control unit 36 performs radio communication control via antenna 7 and radio unit 37.

Audio signal processor unit 38 executes signal processing on audio from microphone 24. Reproduction circuit 18 performs signal reproduction processing to output voice and the like towards speaker 19. Access unit 26 reads out and records data and/or program recorded in detachable recording medium 26A.

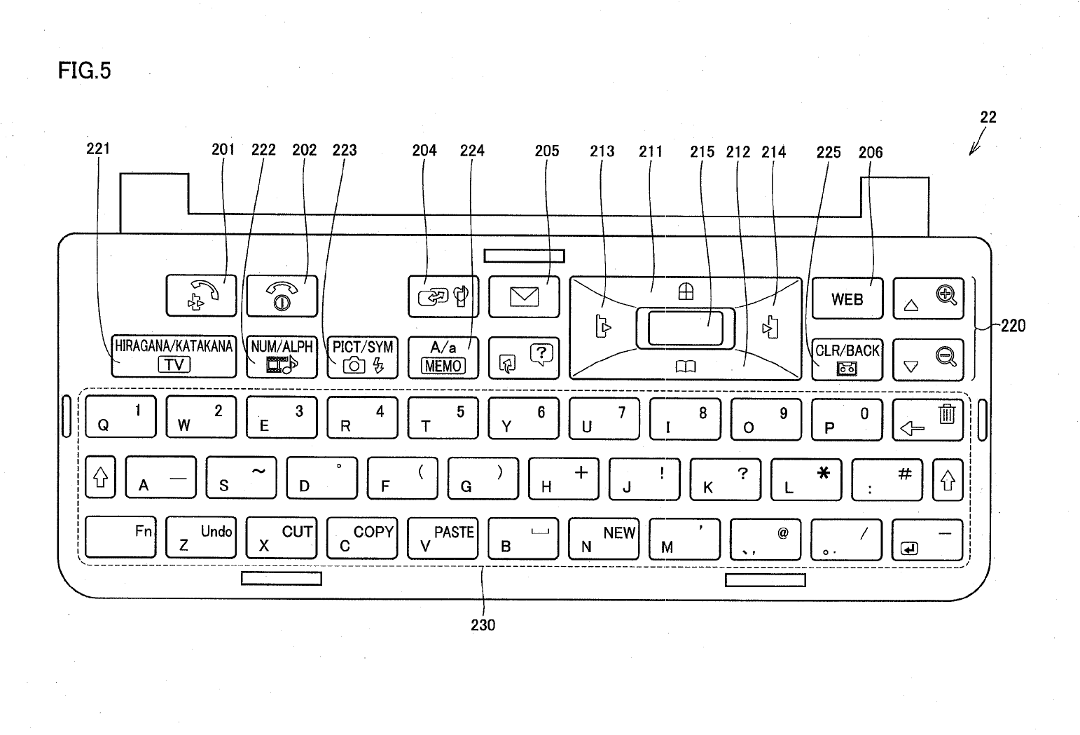

FIG. 5 represents an exemplified arrangement of a plurality of keys of operation unit 22.

Referring to FIG. 5, operation unit 22 includes a first key group 220 to implement various functions of portable information terminal 1, and a second key group 230 used mainly for characters entry. First key group 220 is arranged along two lines at the upper side of the inner surface of second casing 20. Second key group 230 is arranged along three lines at the lower side. The alphabets in second key group 230 are arranged in the QWERTY alignment, likewise with a PC.

First key group 220 includes, along the first line, an off-hook key 201 for accepting a calling operation, an on-hook key 202 for accepting a call-ending procedure or an instruction to end a process, a switch key 204 for accepting an instruction to switch between two active screens displayed at main display unit 16, a mail key 205 for accepting an instruction to execute a mail function, and a WEB (World Wide Web) key 206 for executing a browser function. Along the second row are provided a key 221 to switch between the Japanese characters of hiragana and katakana during character entry, a key 222 to switch between a number character and an alphabet character, a key 223 to switch between a picture character and a symbol, a temporary memo key 224 for accepting an instruction to execute “character temporary storage function” that will be described afterwards, and a clear key 225. Temporary memo key 224 may further include the function to switch between upper-case and lower-case characters during character entry.

At a common region of the first and second lines in first key group 220, there are provided cursor keys 211 to 214 for moving the cursor appearing at main display unit 16 up and down and left and right, and a determination key 215 for accepting an instruction of designation (decision). Cursors keys 211 to 214 and determination key 215 are located between mail key 205 and Web key 206.

A function different from that described above may be assigned to respective keys set forth above.

The alphabet key along the first line among the three lines of keys in second key group 230 has a number allocated thereto.

(Function Configuration)

Referring to FIG. 6, a program PA (hereinafter, also referred to as “temporary memo application”) to realize the character temporary storage (hereinafter, also referred to as “temporary memo”) function, and a plurality of other programs (application programs) related to registration of characters are prestored in ROM 402. The latter plurality of programs include, for example, a program PB to implement a memo registration function (hereinafter, also referred to as “memo application”), a program PC to implement the mail function (hereinafter, referred to as “mail application”), a program PD to implement a schedule registration function (hereinafter, referred to as “schedule book application”), a program PE to implement a Web function (hereinafter, referred to as “browser” or “browser application”), a program PF to implement a registration function of an É-mail address or telephone number (hereinafter, referred to as “address book application”), and a program PG to implement a text file registration function (hereinafter, referred to as “file registration application”).

The basic functions implemented by program PB to PG other than the temporary memo application among the aforementioned programs may be conventional existing functions. It is assumed that the browser application is software to search for information provided by Web server 308. Alternatively, the browser application may be software to search for information provided by information providing server 303. Additionally, both thereof may be provided.

Conventionally, there are applications related to character entry such as the aforementioned memo application (program PB). However, in order to use character data input by the user as character information in another application, the user had to start another application, and then carry out a copy-&-paste operation. The process was rather complicated.

In the present embodiment, a temporary memo application that is software to allow temporary storage of input characters without being restricted by another application can be used. Usage of such a temporary memo application allows the user to register temporarily stored characters, once input, in all other applications through a simple select operation.

Flash memory 403 includes a memory region 4031 for registering the contents of a memo registered through the memo application, a mail region 4032 for storing the mail through the mail application, a schedule region 4033 for registering a schedule through a schedule book application, an address book region 4034 for registering an É-mail address and/or telephone number through an address book application, and a file storage region 4035 for storing a text file through a text application.

RAM 401 has character data temporarily stored through the temporary memo application as information for an operation of portable information terminal 1. In the present embodiment, characters may include a character representing Japanese (kanji and katakana), alphabets, numbers, symbols, face marks (emoticon), and the like, as well as a picture such as a lexigram. Moreover, the characters may be a character string.

Control unit 30 includes, as a main function, a temporary memo control unit 100, a paste control unit 108, and a specific control unit 110.

Temporary memo control unit 100 is a function executed by control unit 30 when the temporary memo application is activated. Temporary memo control unit 100 includes an input processor unit 102, a display processor unit 104, an instruction acceptance unit 106, and a character recognition unit 107.

Input processor unit 102 accepts input of a character from a user via operation unit 22 to carry out a recording (temporary storing) process of the input character into RAM 401.

Display processor unit 104 carries out the process of displaying the characters accepted by input processor unit 102, i.e. characters stored in RAM 401, at main display unit 16. Accordingly, characters input by the user as a temporary memo are displayed at main display unit 16.

Instruction acceptance unit 106 accepts a paste instruction related to the paste destination of temporarily stored characters (temporary memo) via operation unit 22. In other words, instruction acceptance unit 106 accepts an instruction of what the temporary memo is to be used. Each paste destination corresponds to one program (PB-PG).

When an address book application is selected as the paste instruction, character recognition unit 107 executes a predetermined character recognition process on the characters temporarily stored. The character recognition process will be described in detail afterwards.

When a specific program among programs PB to PG set forth above, i.e. a mail program (program PC) or a browser application (program PE), is activated, specific control unit 110 functions to be executed by control unit 30 based on the specific program. Specific control unit 110 includes an extraction unit 112.

When temporary memo key 224 is depressed in a state where a display subject region is displayed at main display unit 16 (called “specific activation state”), extraction unit 112 extracts at least a portion of a character string in a display subject region corresponding to the specified program. Extraction unit 112 outputs the extracted character string to temporary memo control unit 100. Accordingly, at least a portion of the character string in the display subject region is recorded in RAM 401 and displayed at main display unit 16.

As used herein, “display subject region” refers to the entire region of one mail, when in a mail mode, and the entire region of one page, when in a browser application mode. In other words, the display subject region implies, not only the region displayed at main display unit 16 (the region visually perceivable by the user), but also the entire region that can be displayed by scrolling.

Paste control unit 108 responds to acceptance of a paste instruction at instruction acceptance unit 106 to perform paste control of the temporary stored characters. Specifically, a program corresponding to a paste instruction, among the plurality of programs PB to PG stored in ROM 402, is activated, and the temporary stored characters are pasted into the character input region corresponding to that program. Paste control unit 108 is connected to RAM 401, ROM 402, main display unit 16, flash memory 403, and communication control unit 36.

<Operation>

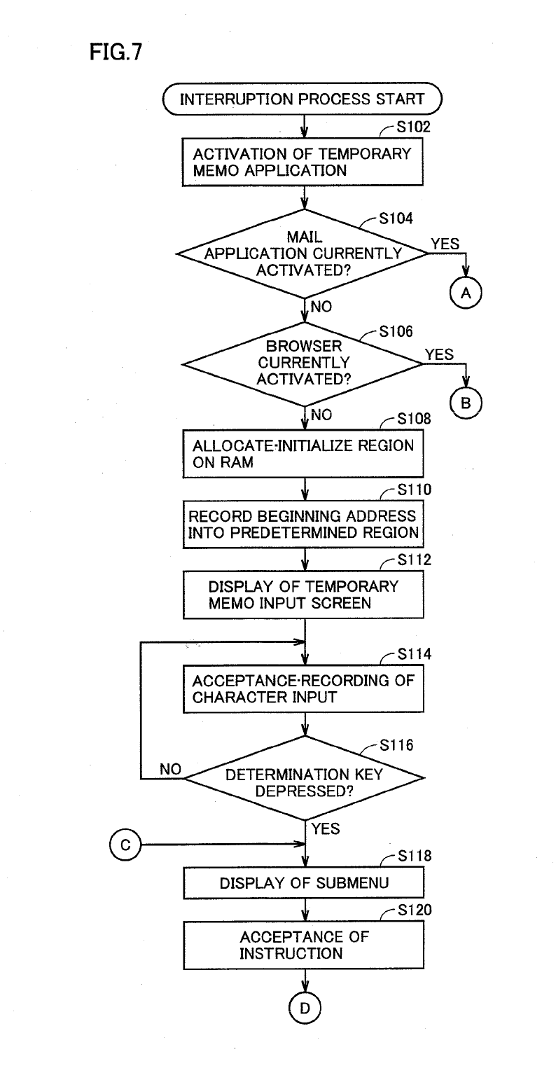

FIGS. 7-10 are flowcharts representing an interruption process executed when temporary memo key 224 is depressed in an embodiment of the present invention.

Referring to FIG. 7, temporary memo control unit 100 first activates the temporary memo application stored in ROM 402 (step S102).

Then, temporary memo control unit 100 determines whether the mail application is currently activated or not (step S104). Here, this determination is made based on whether the mail application is in a specific activation state or not. A specific activation state of the mail application refers to a state where mail already stored such as a reception mail or transmission-completed mail is selected. In other words, it refers to a state where a new mail generation screen or edit screen is not displayed.

When a determination is made that the mail application is currently activated (YES at step S104), control proceeds to step S302. When a determination is made that the mail application is not currently activated (NO at step S104), control proceeds to step S106.

At step S106, temporary memo control unit 100 determines whether the browser is currently activated or not (step S106). This determination is made based on whether the browser is in a specific activation state or not. A specific activation state of a browser refers to a state in which a Web page is displayed.

When a determination is made that the browser is currently activated (YES at step S106), control proceeds to step S402. When a determination is made that the browser is not currently activated (NO at step S106), control proceeds to step S108.

In the present embodiment, activation of the temporary memo application in a specific activation state is termed “multi-activation”, and activation of the temporary memo application when not in a specific activation state is termed “single activation”.

Control may be adapted to prohibit initiation of an interruption process in the case where both the mail application and browser are in a specific activation state at the point of time temporary memo key 224 is depressed.

It is also assumed that there may be an application that cannot be activated simultaneous with the temporary memo application, among the programs other than the mail application and browser. Control may be adapted to prohibit initiation of an interruption process when temporary memo key 224 is depressed in the case where an application that cannot be activated simultaneous to temporary memo application is in an active state. In the present embodiment, a state where a standby screen is displayed, and a state where an application that can be activated simultaneous with the temporary memo application is in a started state is referred to as “a standby state”.

(Single Activation)

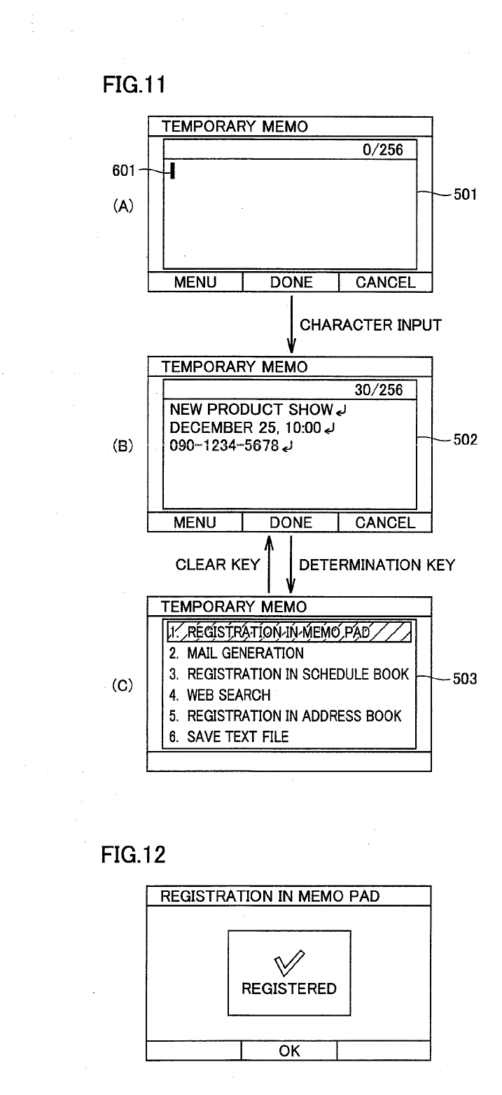

The operation of single activation will be described hereinafter with reference to the exemplified screen display of FIG. 11.

Input processor unit 102 of temporary memo control unit 100 allocates a region of a predetermined number of bytes on RAM 401 and initializes (step S108) the allocated region (hereinafter, referred to as “temporary memo region”). Input processor unit 102 records (step S110) the beginning address of the temporary memo region at a predetermined region on RAM 401 (hereinafter, referred to as “specific region”).

Then, display processor unit 104 of temporary memo control unit 100 causes main display unit 16 to display a temporary memo input screen (step S112). In FIG. 11, (A) represents an exemplified screen displayed at step S112.

Referring to FIG. 11(A), main display unit 16 displays a temporary memo input screen 501. A cursor 601 is displayed in temporary memo input screen 501. Depression of any of the keys in second key group 230 of operation unit 22 by the user allows entry of a character located at the site indicated by cursor 601.

When a temporary memo input screen is displayed, input processor unit 102 accepts entry of a character by the user, and records the accepted character data in the temporary memo region on RAM 401 (step S114). Concurrently with this process, display processor unit 104 performs control to cause main display unit 16 to display the characters accepted by input processor unit 102. At this stage, the accepted characters are displayed as a result of display processor unit 104 reading out the character data recorded on the temporary memo region, for example.

FIG. 11 (B) represents an exemplified screen displayed according to the process of step S114. FIG. 11 (B) shows an example of a temporary memo input screen 502 having characters input. Referring to FIG. 11 (B), temporary memo input screen 502 is entered with “New product show December 25 10:00, 090-1234-5678”, for example.

Temporary memo control unit 100 determines whether determination key 215 is depressed or not (step S116). Input processor unit 102 accepts character input until determination key 215 is depressed (NO at step S116). It is assumed that the determination of whether determination key 215 is depressed or not is made when the input character is in an ascertained state. When determination key 215 is depressed in the case where the input character is not yet ascertained (for example, during character conversion), only the character is ascertained, and control does not proceed to the next step. The same applies to the determination of determination key 215 hereinafter.

When a determination is made that determination key 215 is depressed (YES at step S116), display processor unit 104 causes main display unit 16 to display a submenu related to the paste destination of the temporary memo (step S118). When determination key 215 is depressed in the state where temporary memo input screen 502 is displayed as shown in FIG. 11 (B), submenu screen 503 is displayed, as shown in FIG. 11 (C).

Submenu screen 503 shows a list of six items (items indicating the paste destination), i.e. “registration in memo pad”, “mail generation”, “registration in schedule book”, “Web search”, “registration in address book”, and “save text file”. First, the topmost “registration in memo pad” is displayed in a selected-state indication. The item in a selected-state indication will change in response to depression of cursor keys 211 and 212 by the user. The items indicating the paste destination are not limited to the aforementioned six items, and may include another item as long as it is stored as a program. For example, “save in PDF” for storage as PDF (Portable Document Format), “information search through cellular phone” to search for information presented by information providing server 303 may be included.

Then, instruction acceptance unit 106 accepts an instruction from the user (step S120). Namely, one of the six items displayed on the submenu screen is accepted.

When the user selects any one of the six items displayed on the submenu screen, control proceeds to step S202.

Control may be adapted to return to the process of step S114 when the user depresses clear key 225 at step S120. Namely, when clear key 225 is depressed under the state where submenu screen 503 shown in FIG. 11 (C) is displayed, control may be adapted such that the display of main display unit 16 returns to temporary memo input screen 502 shown in FIG. 11 (B).

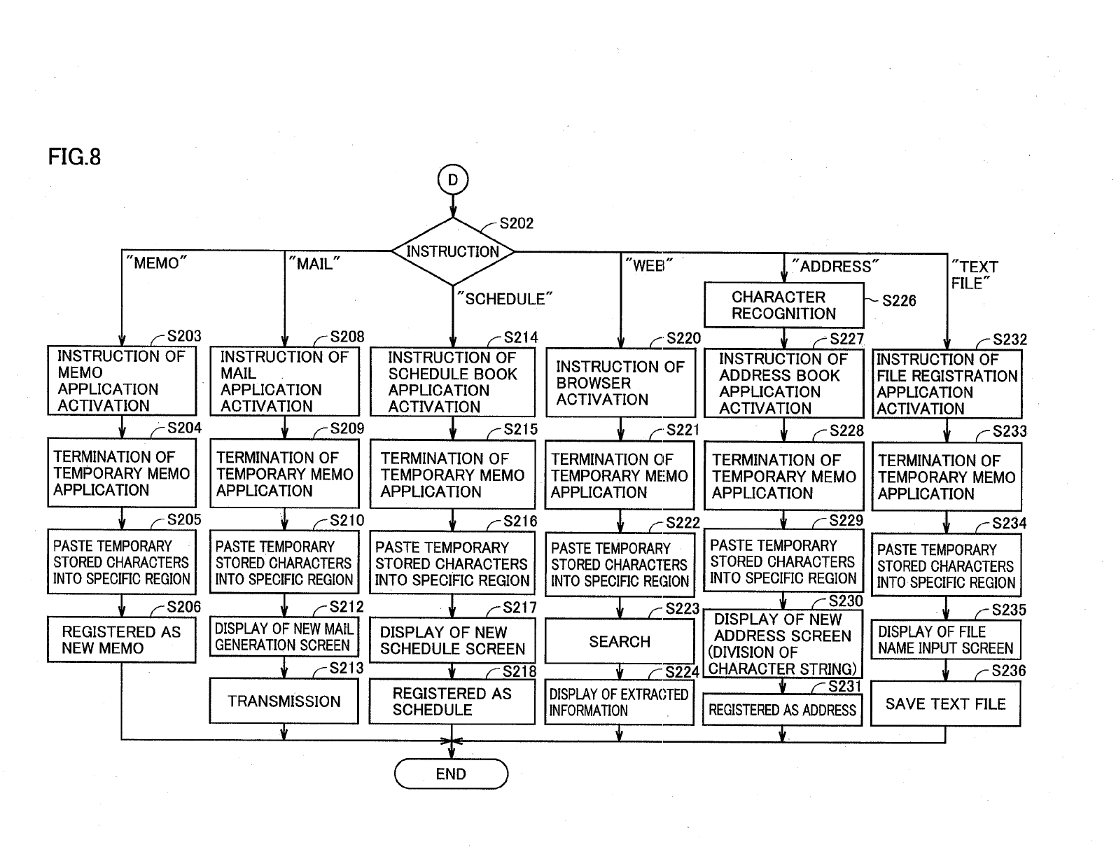

At step S202 in FIG. 8, temporary memo control unit 100 determines which of the items corresponds to the instruction accepted at step S120. When the selected item is “registration in memo pad”, control proceeds to S204. When the selected item is “mail (mail generation)”, control proceeds to step S208. When the selected item is “schedule (registration in schedule book)”, control proceeds to step S214. When the selected item is “WEB (Web search)”, control proceeds to step S220. When the selected item is “address (registration in address book)”, control proceeds to step S226. When the selected item is “text (save text file)”, control proceeds to step S232.

Specific examples in paste control for each of the six items will be described hereinafter.

(1) Registration in Memo Pad

Registration in a memo pad will be described hereinafter with reference to the flowchart of FIG. 8 and the exemplified screen of FIG. 12.

At step S204 in FIG. 8, temporary memo control unit 100 outputs a memo application activation instruction to the middleware. Accordingly, the middleware activates the memo application stored in ROM 402. Following completion of this process, the temporary memo application is terminated (step S204). The middleware is intermediate software between an OS (Operating System) and application software, exchanging various processes required by an application, and conducting various procedures and sequences to be requested to the OS.

Likewise with the registration in a memo pad, temporary memo control unit 100 may be adapted to rewrite the contents of the temporary memo into another region on RAM 401 to suit the application of the paste destination at the point of time the paste destination is selected. In this case, the beginning address of the region subsequent to rewriting is recorded in the specific region.

Then, paste control unit 108 pastes the characters temporarily saved to the specified region of the memo application (step S205). The memo application registers the characters temporarily saved (temporary memo) into the memo pad as the new memo (step S206). At this stage, a “registered” message is displayed at main display 16, as shown in FIG. 12.

To this end, paste control unit 108 first reads out, at the time of activation and initialization of the memo application, the character data in the region (temporary memo region) indicated by the beginning address stored in the specific region, and copies the character data read out into the region specified by the memo application (specified region). The memo application reads out the character data temporarily stored in the specified region, and records the character data read out into memo region 4031 of flash memory 403. Thus, the contents of a temporary memo can be registered as a new memo.

In the event described above, a new memo is registered (step S206) without an editing screen being displayed. Therefore, temporarily saved (temporarily recorded) memo can be permanently stored in the memo pad (secondary recording) through a simple operation.

Similarly in the registration in memo pad mode, a new memo screen (character input region) citing the contents of the temporary memo may be displayed at main display unit 16.

When the process of step S206 ends, paste control unit 108 initializes the specific region in RAM 401. Accordingly, by referring to the specific region when the memo application is activated (during initialization), control unit 30 can determine whether the paste control set forth above is required or not.

Thus, an interruption process is completed, and the display at main display 16 returns to the state prior to depression of temporary memo key 224.

The rewriting process of RAM 401 executed by paste control unit 108 may be implemented by middleware or by the memo application. Alternatively, the rewriting process may be implemented by the temporary memo application. In the case where the temporary memo application is to execute the rewriting process, temporary memo control unit 100 accepts the information of the specified region (address or the like) of the memo application via the middleware, and pastes the contents of the temporary memo into that region following activation of the memo application. The same applies to other applications that will be described afterwards.

(2) Mail Generation

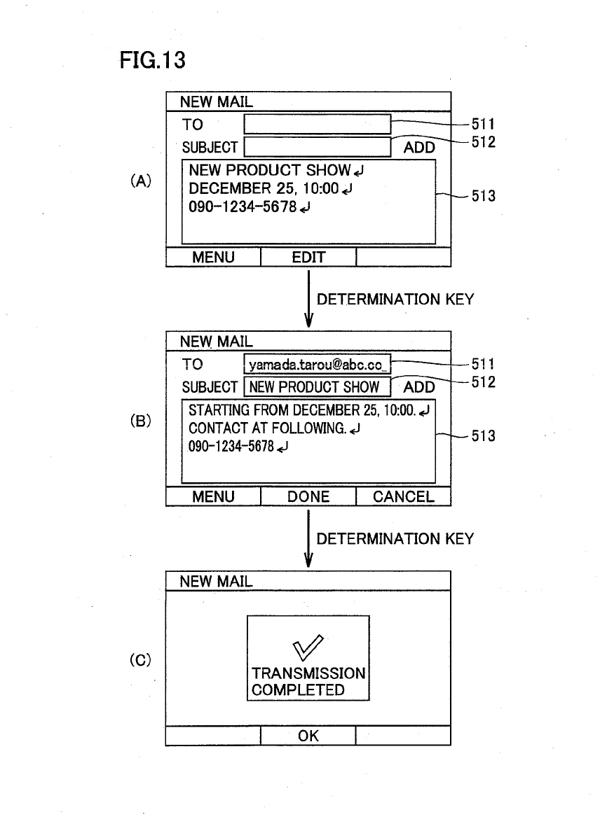

Mail generation will be described with reference to the flowchart of FIG. 8 and the exemplified screen transition of FIG. 13.

At step S208, temporary memo control unit 100 outputs an activation instruction of the mail application to the middleware. In response, the middleware activates the mail application stored in ROM 402. Upon completion of this process, the temporary memo application is terminated (step S209).

Then, paste control unit 108 pastes the temporary stored characters into the specified region of the mail application (step S210). The mail application causes main display unit 16 to display a new mail generation screen with the character data temporarily stored in the specified region as the body text (step S212). FIG. 13 (A) represents an exemplified screen displayed at step S212.

Referring to FIG. 13 (A), a new mail generation screen is displayed at main display unit 16. The new mail generation screen includes an address region 511 for entering the address of destination, a subject line region 512 to enter a subject line, and a body text region 513 to enter the body text.

At body text region 513, the characters input in temporary memo input screen 502 of FIG. 11 (B) are displayed. Thus, upon selecting “mail generation” subsequent to registration in a temporary memo, the contents of the temporary memo is displayed in a state entered in the mail body text. Therefore, the user can store the contents to be entered in the mail body text through a simple operation in advance.

Similarly in this case, paste control unit 108 first reads out, at the time of activation and initialization of the memo application, the character data in the region (temporary memo region) indicated by the beginning address stored in the aforementioned specific region, and copies (or moves) the read character data into the working area of the mail application. Accordingly, a new mail generation screen can be displayed in a state where the temporary memo is entered (in a pasted state) in the body text region of the mail. The temporary memo region in RAM 401 may be directly used as the storage region for the mail body text.

Upon completion of the paste process, the specific region of RAM 401 is initialized for the same reason given above.

When determination key 215 is depressed under the state of FIG. 13 (A), the characters in each region can be edited. In the editing screen of FIG. 13 (B), editing on the characters in body text region 513 of FIG. 13 (A), and/or input of a character into address region 511 and subject line region 512 can be accepted.

Following the process of step S212, the generated new mail is transmitted via communication control unit 36 according to an operation by the user (step S213). When determination key 215 is depressed under the state of FIG. 13 (B), a “transmission completed” message is displayed, as shown in FIG. 13 (C).

Thus, an interruption process is completed, and the display of main display unit 16 returns to the state prior to depression of temporary memo key 224.

(3) Registration in Schedule Book

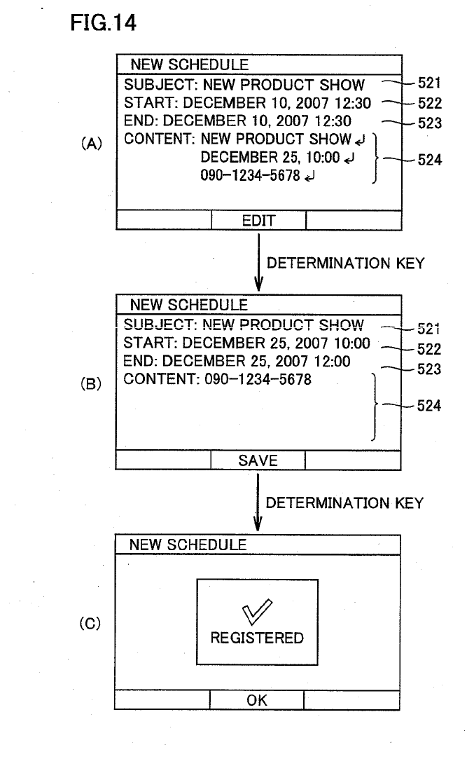

Registration in the schedule book will be described with reference to the flowchart of FIG. 8 and the exemplified screen transition of FIG. 14.

At step S214, temporary memo control unit 100 outputs a schedule book application activation instruction to the middleware. In response, the middleware activates the schedule book application stored in ROM 402. Upon completion of this process, the temporary memo application is terminated (step S215).

Then, paste control unit 108 pastes the temporary saved characters into the specified region of the schedule book application (step S216). The schedule book application causes main display unit 16 to display a new schedule screen citing the character data temporarily stored in the specified region (step S217). FIG. 14 (A) represents an exemplified screen displayed at step S217.

Referring to FIG. 14 (A), main display unit 16 provides a display of a new schedule screen. The new schedule screen includes a subject line region 521 to enter a subject line, a region 522 to enter the starting date and time, a region 523 to enter the ending date and time, and a contents region 524 to enter the specific contents of the schedule.

Characters of a predetermined number (for example, 32 characters) from the beginning of the temporary memo are pasted in subject line region 521. In the case where a line-break code is detected in the predetermined number of characters, the characters up to the line-break code are pasted.

At the point of time of a new schedule screen being first displayed, the current date and time, for example, are displayed in regions 522 and 523 associated with the date and time. Regions 522 and 523 related to the date and time may be left blank.

The characters input in temporary memo input screen 502 of FIG. 11 (B) are displayed at contents region 524. Thus, when “registration in schedule book” is selected following registration in a temporary memo, display is provided with the contents of the temporary memo entered in the schedule contents. Therefore, the user can temporarily save in advance the contents to be registered in the schedule through a simple operation.

Similarly, paste control unit 108 first reads out, at the time of activation and initialization of the schedule book application, the character data in the region (temporary memo region) indicated by the beginning address stored in the aforementioned specific region, and copies (or moves) the read character data into the working area of the schedule book application. Accordingly, a new schedule screen can be displayed in a state where the temporary memo is entered (in a pasted state) in the contents region of the schedule book. The temporary memo region may be directly used as the storage region for the schedule contents.

Upon completion of the paste process, the specific region of RAM 401 is initialized for the same reason given above.

When determination key 215 is depressed under the state of FIG. 14 (A), characters in each region can be edited. In the editing screen of FIG. 14 (B), editing on the characters in subject line region 521 and contents region 524 in FIG. 14 (A), and/or input of characters into regions 522 and 523 related to the date and time are accepted.

Following the process at step S217, the new schedule is registered in schedule region 4033 of a flash memory 403 according to an operation by the user (step S218). When determination key 215 is depressed under the state of FIG. 14 (B), a “registered” message is displayed, as shown in FIG. 14 (C).

Upon completion of the process of step S218, the interruption process is terminated, and the display at main display unit 16 returns to the state before temporary memo key 224 is depressed.

Likewise with the registration in the schedule book, registration in a schedule list can be carried out.

(4) Web Search

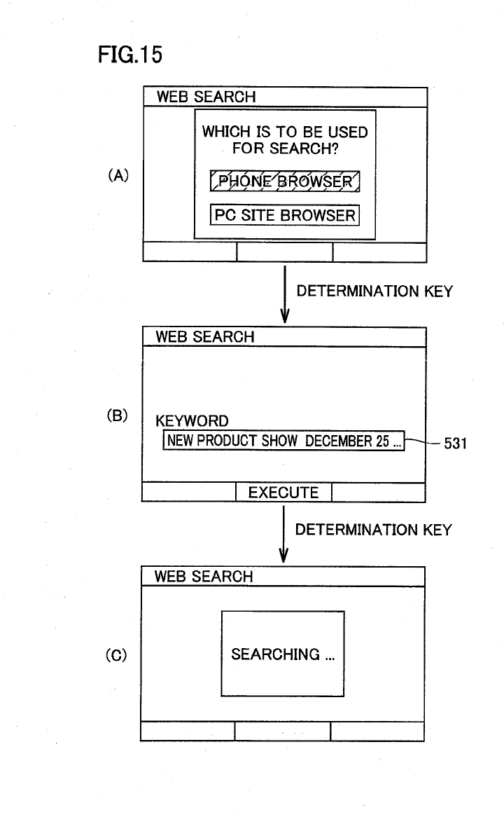

Web search will be described with reference to the flowchart of FIG. 8 and the exemplified screen transition of FIG. 15.

At step S220, temporary memo control unit 100 outputs a browser application activation instruction to the middleware. In response, the middleware activates the browser stored in ROM 402. Upon completion of the process, the temporary memo application is terminated (step S221).

Although description is based on only one browser for Web search in the flowchart for the sake of convenience, the browser to be used for search may be selected by the user, prior to the process of step S220. FIG. 15 (A) represents an example of a selection screen for a browser to be used in the search.

Referring to FIG. 15 (A), main display unit 16 provides the display of a button to select “Phone browser”, and a button to select “PC site browser”, as well as the message of “Which is to be used for search?”. In this case, the browser selected by the user is activated, and the process set forth below is to be executed.

Then, paste control unit 108 pastes the contents of the temporary memo at the keyword storage region (storage region of the search character) specified by the browser application (step S222). The browser application causes main display unit 16 to display a Web search screen with the character data temporarily stored in the specified region as the search character. Specifically, as shown in FIG. 15 (B), at least a portion of the temporary memo contents (for example, a character string of a predetermined number of bits from the beginning, or a character string up to the first line-break code) is pasted in keyword input region 531.

Then, upon depression of determination key 215, the browser application executes a Web search based on the keyword entered in keyword input region 531 (step S223). In this case, the message of “searching . . . ” is displayed, as shown in FIG. 15 (C).

The browser application causes main display unit 16 to display the information extracted as a result of the search (step S224).

Similarly in this case, paste control unit 108 first reads out, at the time of activation and initialization of the browser application, the character data in the region (temporary memo region) indicated by the beginning address stored in the aforementioned specific region, and copies (or moves) the read character data into the working area of the browser. Accordingly, the user can obtain the desired search result by selecting Web search as the paste destination. The temporary memo region may be directly used as the storage region for the search characters. The browser application retains the position information (for example, the beginning address and end address) to specify the region where the search characters is recorded.

Upon completion of the paste process set forth above, it is assumed that the specific region of RAM 401 is initialized for the same reason given above.

Following completion of the process set forth above, the interruption process is terminated, and the display of main display unit 16 returns to the state prior to depression of temporary memo key 224.

(5) Registration in Address Book

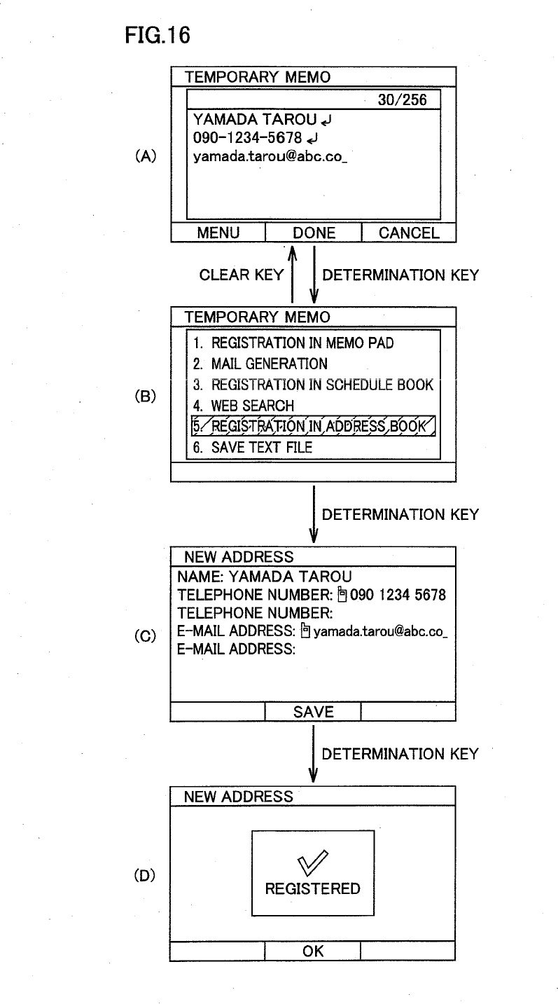

Registration in the address book will be described with reference to the flowchart of FIG. 8 and the exemplified screen transition of FIG. 16.

At step S226 in FIG. 8, character recognition unit 107 executes the character recognition process of the temporary memo contents, and temporarily stores the result as the second temporary memo. Temporary memo control unit 101 records the beginning address of the second temporary memo in the specific region.

Then, temporary memo control unit 100 outputs an address book application activation instruction to the middleware (step S227). Accordingly, the middleware activates the address book application stored in ROM 402. Upon completion of this process, the temporary memo application is terminated (step S228).

FIG. 16 (A) represents the contents of a temporary memo input at step S114. FIG. 16 (B) represents an example of registration in address book being selected in the submenu.

Referring to FIG. 16 (A), the characters of “Yamada Taro”, “090-1234-5678” and “yamada•tarou@abc.co_” are entered, separately in each of the items.

Paste control unit 108 pastes the temporarily stored characters into the specified region of the address book application (step S229). The address book application shows a new address screen with the character data temporarily stored in the specified region in a divided manner corresponding to respective items (step S230). FIG. 16 (C) represents the pasted state of “Yamada Taro”, “090-1234-5678” and “yamada•tarou@abc.co_” in a divided manner in the name item, telephone number item, and É-mail address item in the address book.

Then, upon depression of determination key 215, the address book application registers the items as a new address with the character data of each item set correspondingly in address book region 4034 of flash memory 403 (step S231). At this stage, a message “registered” is displayed, as shown in FIG. 16 (D).

Upon completion of the process set forth above, the interruption process is terminated, and the display of main display unit 16 returns to the state prior to depression of temporary memo key 224.

Similarly in this case, paste control unit 108 copies (or moves), at the time of activation and initialization of the address book application, the character data in the region (temporary memo region) indicated by the beginning address stored in the specific region into the working area of the address book application. Alternatively, the temporary memo region may be directly used as the working area of the address book application.

Following the paste process set forth above, the specific region of RAM 401 is initialized by the same reason given above.

A character recognition process executed at step S226 will be described hereinafter.

(i) E-mail Address

A character string including “@”, having the characters preceding and succeeding the “@” constituted of one or more characters (string), among a predetermined mail subject character group, is extracted as the É-mail address. The character string to be extracted as an É-mail address is, for example, up to 128 characters at most. When the subject character string exceeds 128 characters, that character string will not be recognized as an É-mail address.

The predetermined mail subject character group includes alphabets (upper case, lower case), numbers, and predetermined symbols (“!”, “$”, “%”, “&”, “*”, “+”, “−”, “.”, “/”, “=”, “?”, “̂”, “_”, “'”, “{”, “|”, “}”, “˜”).

Examples are shown hereinafter.
When “abc@def.com” is present in the main text,
“abc@def.com” is extracted as a mail address.
When “abc@def:com” is present in the main text,
“abc@def” is extracted as the mail address, excluding “:com”.
When “abc@(co.jp)” is present in the main text,
not extracted as a mail address.

(ii) Telephone Number

A character string beginning with the number “0” (one-byte, two-byte), a character string beginning with “+”, a character string beginning with “TEL:” (one-byte, upper case, lower case), and a character string beginning with “TEL:+” (one-byte, upper case, lower case) may be extracted as the telephone number.

First, the scheme of recognizing a character string beginning with the number “0” or “+” as a telephone number will be described hereinafter.

The character string begins with “0” or “+”, constituted of characters set forth below (regardless of whether each character is one-byte or two-byte), with the length of at least 10 digits and not more than 32 digits including “0” (also +).

(1) Number “#”

(2) Asterisk “*”

(3) Numbers “0” to “9”

(4) Comma “,”

(5) “P”, “p”

(6) Hyphen “-”

(7) Dash “-”

(8) Minus “−”

(9) Right bracket “(”

(10) Left bracket “)”

However, when any of the characters of (6) to (10) is present, and the following character is other than (1) to (5), the characters succeeding (6) to (10) are not extracted as a telephone number.

Only in the case where the character immediately preceding “0” (the leading “0” is recognized as the telephone number) is (9), the character of (9) is also extracted as a telephone number. When the character immediately preceding “0” is a number, the relevant character string is not recognized to be a telephone number.

When the character string extracted as a telephone number (also referred to as “extracted character string”) is set at a relevant item in the address book, the extracted character string is converted into a character string constituted of a predetermined character group for setting. Examples of conversion are set forth below. It is to be noted that the character group for setting includes numbers “0”˜“9”, “#”, “*”, “,”, and
Two-byte characters are converted into a one-byte character
When any character of (4) and (5) is present, it is converted into “P” (upper case).
When any character of (7) and (8) is present, it is converted into a hyphen “-”.
When any character of (9) and (10) is present, it is deleted.

Specific examples will be described hereinafter.
When “090-1234-5678(10)” is present in the character string,
   “090-1234-5678(10)” is extracted as a telephone number, and “090-1234-567810” is set.
When “0300001111P000p111,222” is present in the character string,
   “0300001111P000p111,222” is extracted as the telephone number, and “0300001111P000P111P222” is set.
When “090-1234-5678 (cell phone)” is present in the character string,
   “090-1234-5678” is extracted as a telephone number and set with “(cell phone)” excluded.
When “(03)-1234-5678---0000” is present in the character string,
   “(03)-1234-5678” is extracted as a telephone number, and “03-1234-5678” is set with “---0000” excluded.

The character string extracted as a telephone number is up to 32 digits at most, excluding “(” and “)”. Any character string exceeding 32 digits is not recognized as a telephone number.

However, when there is a pause (comma “,”, “P”, “p”) in the character string, the following recognition is given. Specifically, if the character succeeding pause is removed from the subject character string and the subject character string is within 32 digits, the characters remaining from which the characters succeeding the pause is eliminated is recognized to be a telephone number. In the case where the subject character string exceeds 32 digits even if the characters succeeding the pause are eliminated from the subject character string, that character string is not recognized to be a telephone number.

Specific examples will be described hereinafter.
When “1234567890123456789012345” is present in the character string.
   not extracted as a telephone number.
When “01245678901245678901234567890123456789” is present in the character string,
   not extracted as a telephone number.
When “01234567890123456789p012345P67,890123456789” is present in the character string,
   “01234567890123456789p012345P67” is extracted as the first telephone number, and “01234567890123456789P012345P67” is set.
When “01234567890123456789p012345P67,09011111111” is present in the character string,
   “01234567890123456789p012345P67” is extracted as the first telephone number, and “01234567890123456789P012345P67” is set. Then, “09011111111” is extracted as second telephone number and set.

Next, the method of recognizing a character string beginning with “TEL:” or “TEL:+” as a telephone number will be described hereinafter.

The character string begins with “TEL:”, constituted of (1) to (5) set forth above, with a length of at least 10 digits and not more than 32 digits (“TEL:” is excluded, “+” included).

Similarly in this case, when any of (6) to (10) is present and the succeeding character thereof is a character other than (1) to (5), the data following the characters of (6) to (10) will not be extracted as a telephone number.

When the character string extracted as a telephone number (extracted character string) is set at a relevant item in the address book, the extracted character string is converted into a character string for address book setting. This operation is similar to that set forth above, provided that the leading “TEL:” is deleted. Therefore, description will not be repeated.

Specific examples will be described hereinafter.
When “TEL:(03)-1234-5678” is present in the character string,
   “TEL:(03)-1234-5678” is extracted as a telephone number, and “03-1234-5678” is set.
When “TEL:0300001111P000p111,222” is present in the character string,
   the character string is extracted as “TEL:0300001111P000p111,222”, and “0300001111P000P111P222” is set.
When “TEL:+(81)-1234-5678” is present in the character string,
   “TEL:+(81)-1234-5678” is extracted as a telephone number, and “TEL:+81-1234-5678” is set, including “+”.
When “TEL:+(81)-1234-5678 (oversea)” is present in the character string,
   “TEL:+(81)-1234-5678” is extracted as a telephone number, and “+81-1234-5678” is set with (oversea) excluded.
When “TEL:(03)-1234-5678---0000” is present in the character string,
   “TEL:(03)-1234-5678” is extracted as a telephone number, and “03-1234-5678” is set with “---0000” excluded.

The character string extracted as a telephone number is up to 32 digits at most, excluding “TEL:”, “(”, and “)”. Any character string exceeding 32 digits is not recognized as a telephone number.

However, when there is a pause in the character string, the same as set for above applies.

Specific examples are provided hereinafter.
When “1234567890123456789012345” is present in the character string,
   the character string is not extracted as a telephone number.
When “01245678901245678901234567890123456789” is present in the character string,
   the character string is not extracted as a telephone number.
When “01234567890123456789p012345P67,890123456789” is present in the character string,
   “01234567890123456789p012345P67” is extracted as the first telephone number, and “01234567890123456789P012345P67” is set.
When “01234567890123456789p012345P67,09011111111” is present in the character string,
   “01234567890123456789p012345P67” is extracted as a first telephone number, and “01234567890123456789P012345P67” is set. Moreover, “09011111111” is extracted as the second telephone number, and set.

(iii) Name

With regards to the character string constituting the temporary memo, the character string from which the characters extracted as an É-mail address and telephone number are eliminated is called the “remaining character string”.

The characters from the beginning to the first line-break code, up to 32 characters at most, in the remaining character string, are extracted as a name (first name or surname). In the case where there is no character up to the first line-break code, the characters, up to the next line-break code, will be taken as the subject of a name.

In the case where there is a memo item in the address book, the remaining character string may be entirely set as a memo (with the character string extracted as a name not deleted).

According to the character recognition process of the present embodiment, a plurality of telephone numbers and É-mail addresses can be extracted at one time. In this case, it is assumed that the new address screen of FIG. 16 (C) provides a display of a plurality of telephone numbers and É-mail addresses.

(6) Save Text File

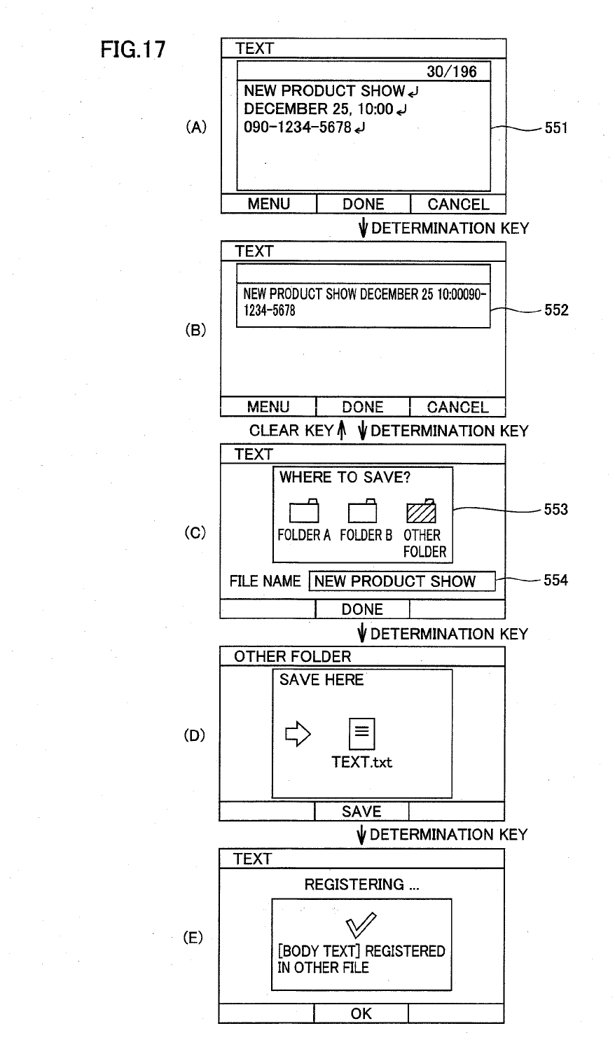

Saving a text file will be described hereinafter with reference to the flowchart of FIG. 8 and the exemplified screen transition of FIG. 17.

At step S232 in FIG. 8, temporary memo control unit 100 outputs an activation instruction of a file registration application to the middleware. Accordingly, the middleware activates the file registration application stored in ROM 402. Upon completion of this process, the temporary memo application is terminated (step S233).

Paste control unit (108) pastes the temporarily saved characters into the specified region of the file registration application (step S234). The file registration application generates a new text file citing the character data temporarily stored in the specified region, and displays a text screen 551, as shown in FIG. 17 (A). The contents of the temporary memo shown in FIG. 11 (B) are pasted in text screen 551. Control may proceed to a file name input screen 552 that will be described afterwards without displaying text screen 551.

Similarly in this case, paste control unit 108 first copies (or moves), at the time of activation and initiation of the text application, the character data of the region (temporary memo region) indicated by the beginning address stored in the specific region into the working area of the text application. Accordingly, a text screen can be displayed with the temporary memo input (pasted) in the body text region of the text.

Upon completion of the paste process set forth above, it is assumed that the specific region of RAM 401 is initialized for the same reason given above.

Upon depression of determination key 215 following generation of a text file, a file name input screen 552 as shown in FIG. 17 (B) is displayed (step S2335). Paste control unit 108 causes a predetermined number of characters in the body text of a text file to be displayed at file name input screen 552. For example, paste control unit 108 sets characters from the beginning up to 196 characters at most (if a line-break code is included, up to the line-break code) as the file name initial value. However, in the case where valid characters for a file name are not included when even as far as the line-break code, the characters up to the next encountered line-break code are to be set as the file name initial value. In the case where valid characters for a file name are not included even up to the end of the input character string, the file name is left empty. In file name input screen 552, the user can edit the file name.

Upon further depression of determination key 215, a screen 553 to select the place to save the text file is displayed, as shown in FIG. 17 (C).

Referring to FIG. 17 (C), a plurality of folder images are displayed at selection screen 553, with one in a selected-state indication. At the bottom of selection screen 553 is displayed a region 554 with the file name entered. A file name can be generated and determined automatically without displaying file name input screen 552, followed by transition to selection screen 553.

The user may further be confronted with the further selection of whether to save in a text region 4035 (main body) of flash memory 403 or in a detachable recording medium 26A (external).

Upon depression of determination key 215 with selection screen 553 in a displayed state, the folder in which the text file is to be saved is selected. Accordingly, the selected folder is open, and the message of “save here” is displayed, as shown in FIG. 17 (D). A further depression of determination key 215 under this state causes the file registration application to save the generated text file (step S236) in the place according to an instruction from the user (for example, memory region 4031 in flash memory 403).

Upon completion of the process set forth above, the interruption process is terminated, and display of main display unit 16 returns to the state prior to depression of temporary memo key 224.

(Multi-Activation)

An operation of multi-activation will be described hereinafter.

(Multi-Activation with Mail Application)

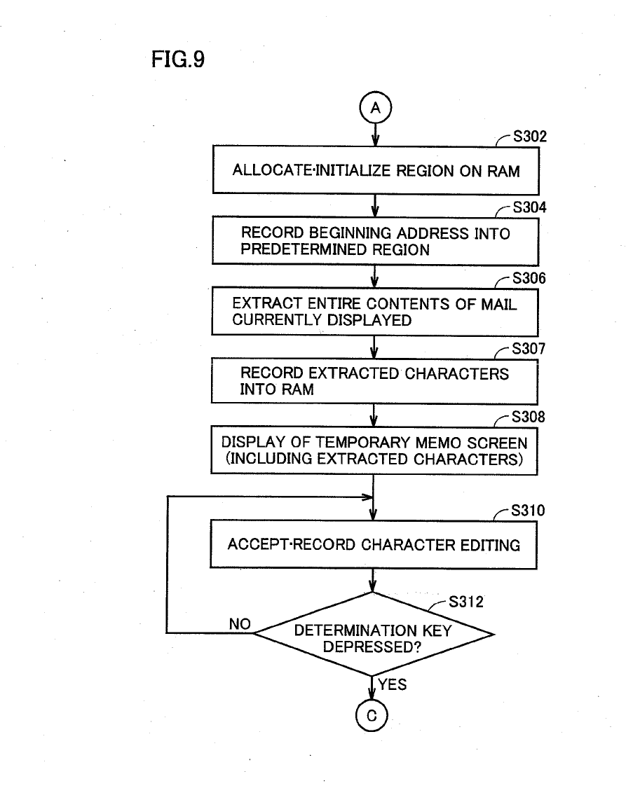

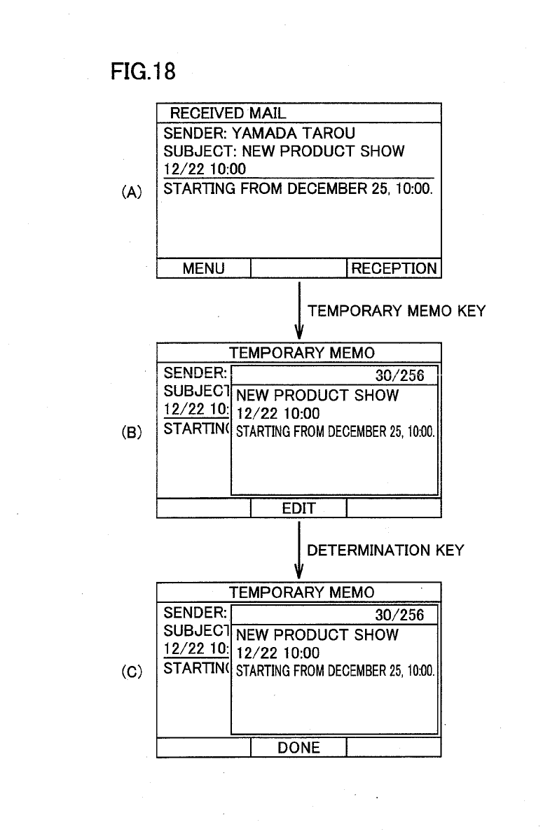

First, an operation of multi-activation with the mail application will be described with reference to the flowchart of FIG. 9 and the exemplified screen transition of FIG. 18.

At step S302 in FIG. 9, temporary memo control unit 100 allocates a region of a predetermined number of bytes on RAM 401, and initializes the allocated region (temporary memo region). Moreover, temporary memo control unit 100 records the beginning address of the temporary memo region in the specific region on RAM 401 (step S304). The processes of steps S302 and S304 are similar to those of steps 108 and S110 corresponding to single activation.

The mail application (extraction unit 112) extracts and provides to temporary memo control unit 100 the entire contents of the display subject region in the currently displayed mail (step S306). Temporary memo control unit 100 records the extracted character data into the temporary memo region of RAM 401 (step S307).

Specifically, when temporary memo key 224 is depressed during mail application activation (specific activation state), the mail application extracts and outputs to temporary memo control unit 100 the beginning address of the character string of each of the transmission date and time, title, and body text of the currently displayed mail. Temporary memo control unit 100 reads out and records into the temporary memo region the character data of the date and time, title and body text based on the received beginning addresses. A line-break code is preferably inserted between each item unit. Furthermore, character data indicating the sender may also be extracted. The date and time of transmission as well as the title are not mandatory, and at least the character data of the body text is to be extracted.

Display processor unit 104 causes main display unit 16 to display a temporary memo input screen in a state where the extracted character strings are included (step S308). A quotation mark may be added to the beginning of the extracted character string in the screen displayed at step S308.

Let us assume that the reception mail shown in FIG. 18 (A) is displayed immediately before depression of temporary memo key 224. In this case, a temporary memo input screen is displayed at the right half region of the display region on main display unit 16, as shown in FIG. 18 (B). In the temporary memo input screen are cited a title (subject name), date and time of transmission, and body text, each on a different line.

Upon depression of determination key 215 under this state, input processor unit 102 accepts character editing, and records the character data based on editing into the temporary memo region (step S310). FIG. 18 (C) shows an editing screen of a temporary memo.

Temporary memo control unit 100 further determines whether determination key 215 is depressed or not (step S312). Character editing is accepted until the determination key is depressed (step NO at step S312). When a determination is made that determination key 215 is depressed (YES at step S312), control returns to step S118 set forth above, and a process similar to that of single activation is executed.

In the case where the “mail generation” item is selected at step S120 (“mail” at step S202) at the time of multi-activation with the mail application, control skips the process of step S204 (activation process), and the process of step S206 is executed. Alternatively, selection of the “mail generation” item may be prohibited in the submenu.

By just depressing temporary memo key 224 when in a multi-activation mode with the mail application, the entire contents of the referred mail are registered in the temporary memo. The user is released from the selection operation of characters and/or the copy-&-paste operation. The operation load on the user is alleviated.

(Multi-Activation with Browser Application)

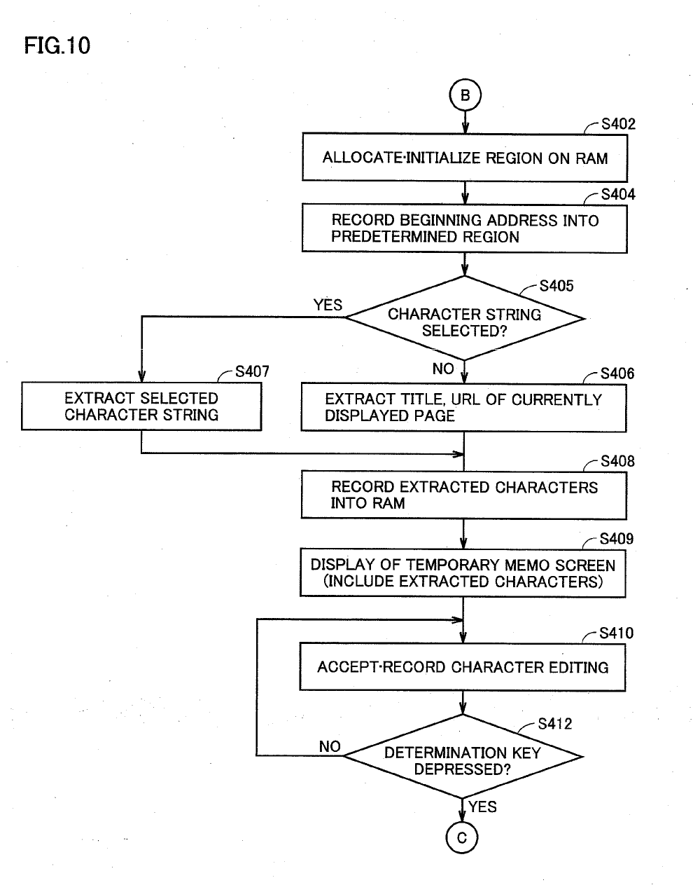

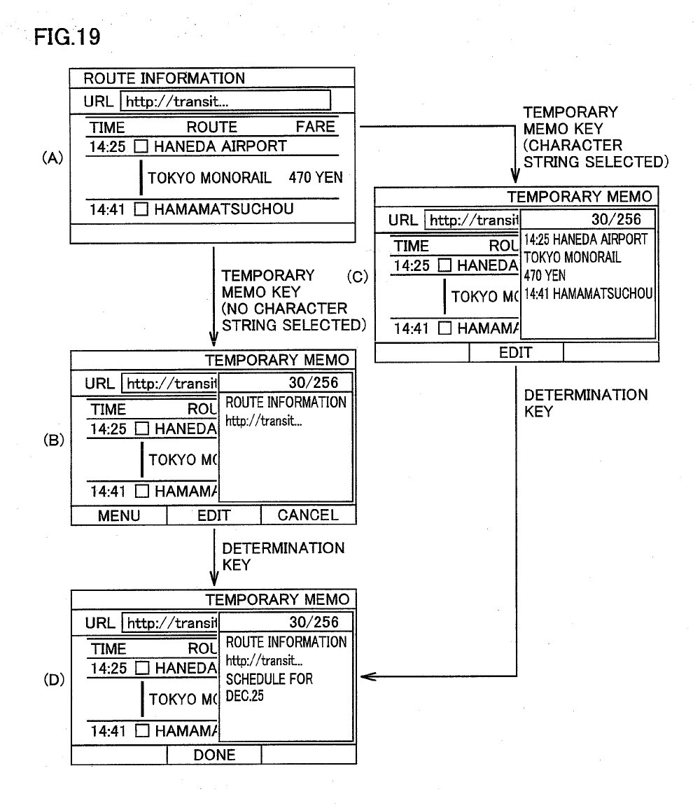

An operation of multi-activation with the browser application will be described hereinafter with reference to the flowchart of FIG. 10 and the exemplified screen transition of FIG. 19.

At step S402 of FIG. 10, temporary memo control unit 100 allocates a region of a predetermined number of bits on RAM 401, and initializes the allocated region (temporary memo region). Temporary memo control unit 100 records the beginning address of the temporary memo region at the specific region on RAM 401 (step S404). The processes of steps S402 and S404 are similar to those of steps S108 and S110 corresponding to single activation.

Then, the browser application (specific control unit 110) determines whether a character string is selected or not in the currently displayed page (step S405). When a determination is made that a character string is not selected (NO at step S405), control proceeds to step S406. When a determination is made that a character string is selected (YES at step S405), control proceeds to step S407.

At step S406, the browser application (extraction unit 112) extracts the character data of the title and URL in the currently displayed page for output to temporary memo control unit 100.

At step S407, browser application (extraction unit 112) extracts and provides to temporary memo control unit 100 the selected character string data.

Subsequent to the process of step S406 or 5407, temporary memo control unit 100 stores the extracted character string data into the temporary memo region of RAM 401 (step S408).

Display processor unit 104 causes main display unit 16 to display a temporary memo input screen under a state where the extracted character string is included (step S409). The screen displayed at step S409 may have a quotation mark added at the beginning of the extracted character string.

When temporary memo key 224 is depressed during browser activation (specific activation state), the browser application outputs, if in a character string selected state, for example, the beginning address and ending address of that character string to temporary memo control unit 100. When not in a character string selected state, the beginning address and ending address of each of predetermined items (title, URL) in the currently displayed page are output to temporary memo control unit 100. Temporary memo control unit 100 reads out the character data recorded from the received beginning address to the ending address, and records the character data read out into the temporary memo region.

It is preferable to insert a line break code between the items. When not in a character string selected state, a character string of a predetermined number of characters from the beginning, among the character group in the body text region of the page, for example, may be extracted, in addition to the title and URL.

Let us assume that a page as shown in FIG. 19 (A) is displayed immediately before temporary memo key 224 is depressed. When temporary memo key 224 is depressed under a state where a character string is not selected, temporary memo input screen as shown in FIG. 19 (B) is displayed. When temporary memo key 224 is depressed under the state where a character string is selected, a temporary memo input screen as shown in FIG. 19 (C) is displayed.

Referring to FIG. 19 (B), a temporary memo input screen is displayed at the right half of the display region in main display unit 16. The temporary memo input screen is displayed with the title of displayed page and URL on different lines corresponding to a line-break.

Referring to FIG. 19 (C), a temporary memo input screen is displayed at the right half of the display region in main display unit 16. The temporary memo input screen is displayed with the selected character string in the displayed page.

When determination key 215 is depressed under the state of FIG. 19 (B) or (C), input processor unit 102 accepts character editing, and records character data based on the editing in the temporary memo region (step S410). FIG. 19 (D) displays the edited screen of the temporary memo.

Temporary memo control unit 100 further determines whether determination key 215 is depressed or not (step S412). Editing of characters is accepted until determination key 215 is depressed (NO at step S412). When a determination is made that determination key 215 is depressed (YES at step S412), control returns to step S118 to execute a process similar to that of single activation.

When the “Web search” item is selected at step S120 at the time of multi-activation with the browser (“WEB” at step S202), the process of step S220 (activation process) may be skipped and the process of step S222 executed.

Although the processes corresponding to a state where a character string is selected and the state where character string is not selected has been provided in the case of multi-activation with the browser, only one of the processes may be in enabled. In this case, when temporary memo key 224 is depressed in the case where a character string is not selected, a screen similar to that of single activation (FIG. 11 (A)) is displayed.

Thus, a selected character string can be cited in the temporary memo input screen in the multi-activation with the browser. Therefore, when the user selects information of interest (character string) and depresses temporary memo key 224, a temporary memo input screen citing the information is displayed. Further, by selecting the paste destination, the information can be readily registered as a memo, saved as a text file, and/or transmitted as mail.

Similar to the multi-activation with the mail application, the selected character string may be cited in the temporary memo input screen.

Thus, in any of a single activation and multi-activation at portable information terminal 1, a temporary memo input screen is displayed through just one depression of temporary memo key 224 by the user. The user can temporarily save a memo through a single operation. The user only has to select the paste destination of the temporary memo from the submenu to allow delivery of the temporary memo to the selected application. In other words, by a temporary memo application qualified as software not bound to each application, a temporarily saved character string is pasted into the character input region of the selected application through a simple operation. Thus, the contents of a temporary memo can be used flexibly as character information in a different application through a simple operation.

In the case of multi-activation, the referred data can be entirely or partially cited for temporary memo registration. Furthermore, in the temporary memo input screen, editing of characters cited from another application and/or addition of user's comments is allowed. Therefore, secondary usage of the temporary memo is readily possible.

Portable information terminal 1 of the present embodiment has, but is not limited to, the configuration in which dedicated hardware (temporary memo key 224) is provided for temporary memo registration. Portable information terminal 1 (operation unit 22) requires only a button that allows activation of a temporary memo application through one operation (depression) in the aforementioned standby state. Therefore, the function of activating the temporary memo application may be assigned to a key having another function, and have the temporary memo application activated when the relevant key is depressed in a standby state. Alternatively, in the case where main display unit 16 of portable information terminal 1 includes a touch panel and also serves as operation unit 22, a button to activate the temporary memo application may be displayed at a predetermined region of main display unit 16 in a standby state.

Operation unit 22 does not necessarily require a button that can activate the temporary memo application through one operation. Activation may be implemented through the display as one of the items in the displayed menu. In this case, when the temporary memo registration item is selected from the menu, temporary memo control unit 100 activates the temporary memo application.

The present embodiment has been described corresponding to the case where the temporary memo is delivered using a specific region on RAM 401. However, the present invention is not limited to such a method, and the temporary memo application may output a pointer to specify a temporary memo region (position information including the beginning address) to the selected application. In this case, the temporary memo application is terminated at the point of time of delivering the pointer to the selected application. It is assumed that an application other than the temporary memo application executes the paste control set forth above, only when a pointer is accepted from the temporary memo application.

The above-described temporary memo application may be provided as a program (temporary character storage program). According to the temporary memo application of the present embodiment, the aforementioned delivery of a temporary memo can be performed by just downloading the application to the portable information terminal, without having to rewrite the processing procedure of another application and/or middleware.

The program may be recorded in a computer readable recording medium such as a memory card to be provided at a program product. The program may also be provided by downloading through a network.

The provided program product is installed into a program storage unit such as a hard disk for execution. The program product includes a program per se, and a recording medium recorded with the program.

It should be understood that the embodiments disclosed herein are illustrative and non-restrictive in every respect. The scope of the present invention is defined by the appended claims, rather than the description set forth above, and all changes that fall within limits and bounds of the claims, or equivalence thereof are intended to be embraced by the claims.

1-15. (canceled)

16. A portable information terminal capable of accepting input of a character, comprising:
an operation unit for accepting input of an instruction from a user,
a display unit,
a storage unit for storing a first program to implement a temporary storage function of characters, a plurality of second programs related to input of characters, and information to operate said portable information terminal, and
a temporary storage control unit for causing, when an activation instruction of said first program is input through said operation unit, said display unit to display a memo input region based on a said first program, and accepting input of characters into said memo input region for controlling temporary storage of characters input into said memo input region,
wherein said temporary storage control unit accepts a paste instruction to specify a program related to a paste destination of characters temporarily stored by said first program, out of said plurality of second programs, and
said portable information terminal further comprises a paste control unit activating a program related to said paste destination in response to acceptance of said paste instruction for performing control to display characters temporarily stored by said first program in a pasted state at the character input region of a screen displayed at said display unit by the activated program.

17. The portable information terminal according to claim 16, wherein said temporary storage control unit displays a list of a plurality of types of character paste destinations corresponding to said plurality of second programs, respectively, when a predetermined instruction is input, and accepts a selection of one of said plurality of types of character paste destinations as said paste instruction.

18. The portable information terminal according to claim 16, wherein said temporary storage control unit terminates a display based on said first program in response to acceptance of said paste instruction.

19. The portable information terminal according to claim 16, further comprising a specific control unit for performing control based on a specific program, out of said plurality of second programs, wherein
said specific control unit includes an extraction unit for extracting, when said activation instruction is input under a specific activation state where a display subject region corresponding to said specific program is displayed at said display unit, a character string of at least a portion in said display subject region, and
said temporary storage control unit temporarily stores characters based on the character string extracted by said extraction unit into said storage unit.

20. The portable information terminal according to claim 19, wherein said temporary storage control unit displays a character string extracted by said extraction unit in said memo input unit, and accepts editing of a character string temporarily stored in said storage unit.

21. The portable information terminal according to claim 19, wherein said specific program includes at least one of a mail program and a Web browser.

22. The portable information terminal according to claim 16, further comprising a communication control unit for performing communication control, wherein
said plurality of second programs include a mail program corresponding to a mail function via said communication control unit, and
when said activated program is said mail program, said character input region includes a body text region of mail.

23. The portable information terminal according to claim 16, wherein
said plurality of second programs include a Web browser,
when said activated program is said Web browser, said character input region includes an input region for search characters.

24. The portable information terminal according to claim 16, wherein
said plurality of second programs include an address program corresponding to a function of address registration,
said temporary storage control unit further includes a recognition processor unit for executing a recognition process of said character string temporarily stored to extract at least any of a name, telephone number, and mail address, when said activated program is said address program,
said paste control unit pastes the extracted character string into said character input region based on said recognition process.

25. The portable information terminal according to claim 16, wherein said operation unit includes a button for accepting said activation instruction through one operation.

26. The portable information terminal according to claim 16, wherein said storage unit includes
a nonvolatile storage device for storing said first program and said second program, and
a volatile storage device for storing data of characters to be temporarily stored.

27. A method for delivering characters between different programs in a portable information terminal including an operation unit for accepting input of an instruction from a user, a storage unit, a display unit and a processing unit, said method comprising:
a step of activating a first program stored in said storage unit when an activation instruction of the first program to implement a temporary storage function of characters is input through said operation unit,
a step of temporarily storing characters input in a memo input region into said storage unit by displaying said memo input region at said display unit, based on said first program, and
accepting input of characters into said memo input region, a step of accepting a paste instruction to specify a program related to a paste destination of characters temporarily stored by said first program, out of a plurality of second programs related to input of characters,
a step of activating a program related to said paste destination in response to acceptance of said paste instruction, and
a step of displaying characters temporarily stored by said first program in a pasted state at a character input region of a screen displayed at said display unit by the activated program.

28. The delivery method according to claim 27, further comprising a step of displaying a list of a plurality of types of character paste destinations corresponding to said plurality of second programs, respectively, when a predetermined instruction is input,
wherein said step of accepting a paste instruction accepts a selection of one of said plurality of types of character paste destinations as said paste instruction.

29. The delivery method according to claim 27, further comprising a step of extracting, when said activation instruction is input under a specific activation state where a display subject region corresponding to a specific program out of said plurality of second programs is displayed, a character string of at least a portion in said display subject region,
wherein said step of temporarily storing characters temporarily stores characters based on an extracted character string into said storage unit.

30. A program product for temporarily storing characters to deliver characters between different programs, causing a computer to execute:
a step of temporarily storing characters input in said memo input region by displaying said memo input region at the display unit, and accepting input of characters into said memo input region, and
a step of accepting a paste instruction to specify a program, out of other programs, related to a paste destination of characters temporarily stored.
